(19) United States
(12) Patent Application Publication
(10) Pub. No.: US 2003/0041920 A1
(43) Pub. Date: Mar. 6, 2003

(54) Coated r-t-b magnet and method for preparation thereof

(76) Inventors: Hiroyuki Hoshi, Saitama-ken (JP); Setsuo Ando, Saitama-ken (JP)

Correspondence Address: SUGHRUE MION, PLLC, 2100 PENNSYLVANIA AVENUE, N.W., WASHINGTON, DC, 20037, US

(21) Appl. No.: 10/088,169

(22) PCT Filed: Jul. 17, 2001
(86) PCT No.: PCT/JP01/06176

(30) Foreign Application Priority Data
Jul. 17, 2000 (JP) 2000-216016
Dec. 21, 2000 (JP) 2000-389490

(51) Int. Cl. H01F 1/057

(52) U.S. Cl. 148/122; 148/302

(57) ABSTRACT

A method for preparing a coated R-T-B magnet wherein a R-T-B magnet having a R₂T₁₄B intermetallic compound, wherein R represents al least one of the rare earth elements including Y, T represents Fe or Fe and Co, as a primary phase is subjected to a chemical treatment, characterized in that the R-T-B magnet is treated with a chemical treating solution which has a molar ratio of Mo to P, Mo/P, of 12 to 60, contains a molybdophosphiate ion as a primary component and is adjusted to have a pH of 4.2 to 6. The resultant chemical coating comprises an oxide of Mo and a hydroxide of R. The oxide of Mo consists essentially of amorphous MoO₂.

### FIELD OF THE INVENTION

The present invention relates to an R-T-B magnet having a chemical conversion layer containing no chromium, and a method for producing such a coated R-T-B magnet.

### BACKGROUND OF THE INVENTION

R—Fe—B magnets, wherein R is at least one of rare earth elements including Y, are particularly easily rusted among rare earth magnets, and they have conventionally been used with their surfaces coated with various plating and chemical conversion layers.

Japanese Patent Laid-Open No. 60-63902 discloses a rare earth magnet provided with improved oxidation resistance by successively laminating a chemical conversion layer and a resin layer on a surface of an R—Fe—B magnet. Described in Example 1 of this reference is that a chromate coating formed on the R—Fe—B magnet by a chromate treatment has good corrosion resistance.

However, the chromate coating described in Japanese Patent Laid-Open No. 60-63902 disadvantageously contains chromium (VI) harmful to humans. The ban of using chromium (VI) is going to be enacted after 2003 in Europe. Accordingly, R-T-B magnets having new chemical conversion layers having excellent corrosion resistance and thermal demagnetization resistance without containing chromium, and methods for forming such chemical conversion layers are desired.

### OBJECT OF THE INVENTION

Accordingly, an object of the present invention is to provide an R-T-B magnet provided with a chemical conversion layer having good corrosion resistance and oxidation resistance without containing chromium and with extremely little demagnetization of a magnet substrate, and a method for producing such a chemical conversion layer-coated R-T-B magnet.

### DISCLOSURE OF THE INVENTION

The first coated R-T-B magnet of the present invention comprises an R-T-B magnet containing as a main phase an R₂T₁₄B intermetallic compound, wherein R is at least one of rare earth elements including Y, and T is Fe or Fe and Co, and a chemical conversion layer formed thereon, the chemical conversion layer containing an oxide of Mo and a hydroxide of R. The oxide of Mo is usually substantially amorphous MoO₂.

The second coated R-T-B magnet of the present invention comprises an R-T-B magnet containing as a main phase an R₂T₁₄B intermetallic compound, wherein R is at least one of rare earth elements including Y, and T is Fe or Fe and Co, and a chemical conversion layer formed thereon, the chemical conversion layer containing pyrophosphoric acid, a hydroxide of R and an oxide of Mo. The oxide of Mo is usually amorphous MoO₂.

With a resin, particularly an epoxy resin, a polyparaxylylene resin or a chlorinated polyparaxylylene resin, further coated on the chemical conversion layer, both coated R-T-B magnets exhibit excellent corrosion resistance and thermal demagnetization resistance. Also, when the resin is formed on the chemical conversion layer via a coupling agent coating, their corrosion resistance and thermal demagnetization resistance are further improved.

The first method for producing a coated R-T-B magnet according to the present invention comprises subjecting an R-T-B magnet containing as a main phase an R₂T₁₄B intermetallic compound, wherein R is at least one of rare earth elements including Y, and T is Fe or Fe and Co, to a chemical conversion treatment using a chemical conversion treatment solution containing molybdophosphate ion as a main component and having a molar ratio Mo/P of 12-60 and pH controlled to 4.2-6. In this chemical conversion treatment solution, molybdate ion and phosphoric ion exist in equilibrium with molybdophosphate ion as a main component.

The second method for producing a coated R-T-B magnet according to the present invention comprises subjecting an R-T-B magnet containing as a main phase an R₂T₁₄B intermetallic compound, wherein R is at least one of rare earth elements including Y, and T is Fe or Fe and Co, to a chemical conversion treatment using a chemical conversion treatment solution containing phosphoric ion as a main component and having a molar ratio Mo/P of 0.3-0.9 and pH controlled to 2-5.8. In this chemical conversion treatment solution, molybdate ion and molybdophosphate ion exist in equilibrium with phosphoric ion as a main component.

### BRIEF DESCRIPTION OF THE DRAWINGS

FIG. 1 is a graph showing the relations between the amounts of molybdenum, phosphorus, iron and neodymium in the chemical conversion layers and the amount of sodium molybdate in the chemical conversion treatment solutions in Sample Nos. 2-5, in which the concentration of phosphoric acid was constant;

FIG. 2 is a graph showing the relations between the amounts of molybdenum, phosphorus, etc. in the chemical conversion layers and the concentration of phosphoric acid in the chemical conversion treatment solutions of Sample Nos. 6-9, in which the amount of molybdate was constant;

FIG. 3 is a graph showing the change, with chemical conversion treatment time, of the amounts of molybdenum, phosphorus, etc. in the chemical conversion layer of Sample No. 16;

FIG. 4 is a graph showing the analysis results of the chemical conversion layer surface by SEM-EDX in Sample No. 29 of Example 3;

FIG. 5 is a graph showing the analysis results of the chemical conversion layer by X-ray diffraction in Sample No. 29 of Example 3;

FIG. 6 is a graph showing the analysis results of the chemical conversion layer surface by ESCA in Sample No. 29 of Example 3;

FIG. 7 is a graph showing the plots of the analysis results of phosphorus and molybdenum by SEM-EDX in the chemical conversion layers against the amount of sodium molybdate in Sample Nos. 57-62 of Example 6;

FIG. 8 is a graph showing the plots of the analysis results of iron and neodymium by SEM-EDX in the chemical conversion layers against the amount of sodium molybdate in Sample Nos. 57-62 of Example 6;

FIG. 9 is a graph showing the plots of the analysis results of phosphorus and molybdenum by SEM-EDX in the chemical conversion layers against the pH of chemical conversion treatment solutions in Sample Nos. 63-68 of Example 7 and Comparative Example 9;

FIG. 10 is a graph showing the plots of the analysis results of iron and neodymium by SEM-EDX in the chemical conversion layers against the pH of chemical conversion treatment solutions in Sample Nos. 63-68 of Example 7 and Comparative Example 9;

FIG. 11 is a graph showing the plots of the analysis results of phosphorus and molybdenum by SEM-EDX in the chemical conversion layers against the chemical conversion treatment time in Sample Nos. 69-72 of Example 8;

FIG. 12 is a graph showing the plots of the analysis results of iron and neodymium by SEM-EDX in the chemical conversion layers against the chemical conversion treatment time in Sample Nos. 69-72 of Example 8;

FIG. 13 is a graph showing the analysis results by SEM-EDX of the chemical conversion layer surface of Sample No. 68 in Example 7;

FIG. 14 is a graph showing the analysis results by X-ray diffraction of the chemical conversion layer of Sample No. 68 in Example 7;

FIG. 15 is a graph showing the analysis results by ESCA of the chemical conversion layer surface of Sample No. 68 in Example 7; and

FIG. 16 is a schematic cross-sectional view showing the R-T-B magnet coated with a chemical conversion layer of Sample No. 68 in Example 7.

### THE BEST MODE FOR CARRYING OUT THE INVENTION

[1] R-T-B Magnet

The R-T-B magnet, on which a chemical conversion layer of the present invention is formed, comprises as a main phase an R₂T₁₄B intermetallic compound comprising 27-34% by weight of R and 0.5-2% by weight of B, the balance being T, with the total amount of R, B and T as main components being 100% by weight. Based on the weight (100% by weight) of the R-T-B magnet, the permitted amounts of inevitable impurities are such that oxygen is 0.6% by weight or less, preferably 0.3% by weight or less, more preferably 0.2% by weight or less; carbon is 0.2% by weight or less, preferably 0.1% by weight or less; nitrogen is 0.08% by weight or less, preferably 0.03% by weight or less; hydrogen is 0.02% by weight or less, preferably 0.01% by weight or less; and Ca is 0.2% by weight or less, preferably 0.05% by weight or less, more preferably 0.02% by weight or less.

Preferably selected as R is practically (Nd, Dy), Pr, (Pr, Dy) or (Nd, Dy, Pr). The content of R is preferably 27-34% by weight, more preferably 29-32% by weight. When R is less than 27% by weight, the intrinsic coercivity iHc drastically decreases. On the other hand, when it is more than 34% by weight, the residual magnetic flux density Br drastically decreases.

The content of B is preferably 0.5-2% by weight, more preferably 0.8-1.5% by weight. When the content of B is less than 0.5% by weight, a practically acceptable iHc cannot be obtained. On the other hand, when it is more than 2% by weight, Br drastically decreases.

To improve the magnetic properties, at least one element selected from the group consisting of Nb, Al, Co, Ga and Cu is preferably contained.

The content of Nb is preferably 0.1-2% by weight. The addition of Nb leads to the formation of Nb boride during the sintering process, thereby suppressing the abnormal growth of crystal grains. However, when the content of Nb is less than 0.1% by weight, sufficient addition effect cannot be obtained. On the other hand, when it is more than 2% by weight, a large amount of Nb boride is formed, resulting in drastic decrease in Br.

The content of Al is preferably 0.02-2% by weight. When the content of Al is less than 0.02% by weight, the effect of improving coercivity and oxidation resistance cannot be obtained. On the other hand, when it is more than 2% by weight, Br drastically decreases.

The content of Co is preferably 0.3-5% by weight. When the content of Co is less than 0.3% by weight, the effect of improving Curie temperature and corrosion resistance cannot be obtained. On the other hand, when it is more than 5% by weight, Br and iHc drastically decrease.

The content of Ga is preferably 0.01-0.5% by weight. When the content of Ga is less than 0.01% by weight, the effect of improving iHc cannot be obtained. On the other hand, when it is more than 0.5% by weight, Br remarkably decreases.

The content of Cu is preferably 0.01-1% by weight. Though the addition of a trace amount of Cu leads to improvement in iHc, the addition effect is saturated when the content of Cu exceeds 1% by weight. On the other hand, when the content of Cu is less than 0.01% by weight, sufficient addition effect cannot be obtained.

Preferable R-T-B magnets on which the chemical conversion layers of the present invention are formed may be in the form of ring magnets having radial anisotropy or polar anisotropy, flat ring magnets of 5-50 mm in outer diameter, 2-30 mm in inner diameter and 0.5-2 mm in axial length (thickness) with anisotropy in their thickness directions, and thin, plate-shaped magnets of 2.0-6.0 mm in length, 2.0-6.0 mm in width and 0.4-3 mm in thickness with anisotropy in their thickness directions suitable for actuators of pickup devices of CD or DVD, etc.

[2] Pretreatment

To obtain the chemical conversion layer having excellent adhesion and corrosion resistance, a surface of the R-T-B magnet on which a chemical conversion treatment is carried out should be cleaned. To remove cutting dust, oils, etc. from the surface of the R-T-B magnet substrate worked to the predetermined shape, for instance, the R-T-B magnet substrate is immersed in an aqueous solution containing a surfactant for cleaning. It is preferable to utilize ultrasonic cleaning during the immersion of the R-T-B magnet substrate.

Next, the R-T-B magnet substrate is immersed in an aqueous alkaline solution at pH of 9-13.5 for pretreatment, to degrease the surface of the R-T-B magnet substrate without deteriorating its magnetic force. The deterioration of a magnetic force can be prevented by using an aqueous alkaline solution for the pretreatment solution, because an R component, etc. are suppressed to be dissolved away from the R-T-B magnet. When the aqueous alkaline solution has pH of less than 9, there is no sufficient degreasing effect. On the other hand, even when the pH is more than 13.5, the degreasing effect is saturated, only resulting in increase in cost. The aqueous alkaline solution having pH of 9-13.5 can be prepared, for instance, by dissolving hydroxides (NaOH, etc.) or carbonates (Na₂CO₃, etc.) of known alkaline metals in the predetermined amounts in water.

It is preferable that the pretreatment is usually carried out at room temperature. Though the immersion time is not particularly restricted, it is preferably 1-60 minutes, more preferably 5-20 minutes in industrial production. After immersion, the pretreatment solution is removed, and the pretreated magnet is fully washed with water.

[3] Chemical Conversion Treatment

(A) Chemical Conversion Treatment Solution

The chemical conversion treatment solution used in the present invention may be classified into the following two types, depending on a molar ratio of Mo to P and pH.

(1) First Chemical Conversion Treatment Solution

The first chemical conversion treatment solution has Mo/P of 12-60, containing molybdophosphate ion as a main component with its pH controlled to 4.2-6. This chemical conversion treatment solution may be prepared by adding 3-20 g/L of a molybdate compound and 0.02-0.15 g/L of phosphoric acid to pure water and controlling the pH to 4.2-6. The molybdenum phosphate as a main component is contained in an amount of about 1-6 g/L. When a chemical conversion treatment is carried out by this chemical conversion treatment solution, it is possible to provide the R-T-B magnet with a chemical conversion layer having good corrosion resistance and thermal demagnetization resistance. When the Mo/P is less than 12, it is difficult to form a chemical conversion layer. On the other hand, when the Mo/P is more than 60, excess Mo is wasted. The Mo/P is preferably 15-50.

When the amount of molybdophosphate ion formed in the chemical conversion treatment solution is less than 1 g/L, the formation of a chemical conversion layer on the surface of the R-T-B magnet is practically insufficient, resulting in the coated R-T-B magnet with poor corrosion resistance. On the other hand, when the amount of molybdophosphate ion formed is more than 6 g/L, excess molybdophosphate ion is wasted.

When the pH of the chemical conversion treatment solution is less than 4.2, the chemical conversion treatment extremely deteriorates the magnetic force of the R-T-B magnet. On the other hand, when the pH is more than 6, a reaction by which molybdophosphate ion is turned to molybdenum blue occurs, resulting in the deterioration of the chemical conversion treatment solution. The preferred pH is 4.5-6.0.

(2) Second Chemical Conversion Treatment Solution

The second chemical conversion treatment solution has Mo/P of 0.3-0.9, containing phosphoric ion as a main component with its pH controlled to 2-5.8. The phosphoric acid as a main component is contained in the chemical conversion treatment solution in an amount of about 0.3-3 g/L. This chemical conversion treatment solution may be prepared by adding 15-70 g/L of a molybdate compound and 0.9-30 g/L of phosphoric acid to pure water. The amount of the molybdate compound added is preferably 15-60 g/L, and the amount of phosphoric acid added is preferably 0.9-5 g/L. The pH of the chemical conversion treatment solution is preferably 2.5-3.5.

When [Mo/P] is outside the range of 0.3-0.9, it is difficult to coat the magnet with a chemical conversion layer. Namely, when the amount of phosphoric acid added is outside the range of 0.9-30 g/L, the chemical conversion layer practically does not attach to the R-T-B magnet, resulting in poor corrosion resistance.

When the amount of molybdate compound added is outside the range of 15-70 g/L, the chemical conversion layer practically does not attach to the R-T-B magnet, resulting in poor corrosion resistance. When the pH is less than 2, the chemical conversion treatment remarkably deteriorates the magnetic force of the R-T-B magnet, making it difficult to form the chemical conversion layer on the R-T-B magnet. Also, when the pH is more than 5.8, it is also difficult to form the chemical conversion layer on the R-T-B magnet.

(B) Chemical Conversion Treatment Conditions

Known chemical conversion treatment methods, such as an immersion method, a spraying method, a blushing method, a roller coating method, a steam gun method, a TFS method (method for treating a metal surface with trichloroethylene), a blasting method, a one-booth method, etc., may be applied to the R-T-B magnet. Among them, the immersion method is most practical.

In the case of the immersion method, the temperature of the chemical conversion treatment solution is preferably 5-70° C., more preferably between room temperature and 50° C. When the bath temperature is lower than 5° C., the reaction of forming the chemical conversion layer is remarkably slow, and precipitation occurs in the bath, resulting in the variation of the composition of the chemical conversion treatment solution. On the other hand, when the bath temperature is higher than 70° C., the chemical conversion treatment solution remarkably evaporates, resulting in difficulty in controlling the chemical conversion treatment solution.

The immersion time of the R-T-B magnet in the chemical conversion treatment solution is preferably 3-60 minutes, more preferably 5-15 minutes. When the immersion time is less than 3 minutes, the chemical conversion layer cannot practically be formed on the surface of the R-T-B magnet. On the other hand, when it is more than 60 minutes, the thickness of the chemical conversion layer is saturated.

To provide the R-T-B magnet with good corrosion resistance, adhesion and thermal demagnetization resistance, the chemical conversion layer preferably has a thickness (average value) of 5-30 nm.

(C) Components in Chemical Conversion Treatment Solution

Preferable as the molybdate compound is molybdate, particularly Na₂MoO₄.2H₂O. Also, preferable as phosphoric acid is orthophosphoric acid (H₃PO₄).

Depending on the oxidation state, phosphorus may exist in the form of phosphine (valence: −3), diphosphine (valence: −2), a simple substance (valence: 0; yellow phosphorus, red phosphorus, black phosphorus), phosphinic acid (valence: +1, HPH₂O₂), phosphonic acid (valence: +3, H₂PHO₂), hypophosphoric acid [valence: +4, (HO)₂OP—PO(OH)₂], or orthophosphoric acid (valence: +5, H₃PO₄). Among them, the molybdenum phosphate contained in the chemical conversion treatment solution is orthophosphoric acid or phosphonic acid bonded to molybdic acid.

When phosphonic acid is used, the molybdenum phosphate is M₄[P₂MoO₁₂O₄₁].nH₂O, wherein M is Li, Na, K, NH₄, CN₃H₆, etc., and n is a positive integer; or 2M₂O.P₂O₃.5MoO₃.nH₂O, wherein M is Na, K, NH₄, etc., and n is a positive integer. Also, when orthophosphoric acid is used, the molybdenum phosphate is 12-molybdophosphate [M₃(PO₄Mo₁₂O₃₆)], 11-molybdophosphate [M₇(PMo₁₁O₃₉)], 5-molybdo-2-phosphate (M₆P₂Mo₅O₂₁), 18-molybdo-2-phosphate (M₆ [(PO₄Mo₉O₂₇)₂]), or 17-molybdo-2-phosphate [M₁₀(P₂Mo₁₇O₆₁)], etc. 12-molybdophosphate is turned to 11-molybdophosphate by an alkaline treatment, and further to 5-molybdo-2-phosphate by an alkaline treatment or a treatment with phosphate. Conversely, 11-molybdenum phosphate is turned to 12-molybdophosphate by a treatment with a strong acid. Thus, the molybdenum phosphate formed by using orthophosphoric acid may be in the form of 12-molybdophosphate, 11-molybdophosphate, 18-molybdo-2-phosphate, etc., depending on the difference of the molybdenum content. Among them, it is preferable to use 12-molybdophosphate or 12-molybdophosphate.n(hydrate) to enhance the corrosion resistance.

[4] Resin Coating

The R-T-B magnet of the present invention may be coated with known resins such as thermoplastic resins (polyamide resins or polyparaxylylene resins, chlorinated polyparaxylylene resins, etc.) or thermosetting resins (epoxy resins, etc.). When emphasis is placed on recycling, the thermoplastic resins are suitable. And when heat resistance is important, the thermosetting resins are suitable. Particularly, the coating of polyparaxylylene resins or chlorinated polyparaxylylene resins preferably has extremely low gas and water vapor permeability because of few pinholes. The polyparaxylylene resins or the chlorinated polyparaxylylene resins may be Parylene N (tradename of polyparaxylylene), Parylene C (tradename of polymonochloroparaxylylene), Parylene D (tradename of polydichloroparaxylylene), etc. available from Union Carbide of the U.S.

The resin coating may be carried out by a known method such as an electrodeposition method, a spraying method, a coating method, an immersion method, a vapor deposition method, or a plasma polymerization method, etc., and the electrodeposition method or the vapor deposition method is suitable from the aspect of practicability.

To impart good corrosion resistance, the thickness (average value) of the resin coating is preferably 0.5-30 μm, more preferably 5-20 μm. When the thickness of the resin coating is less than 0.5 μm, there is no effect of improving the corrosion resistance. On the other hand, when it is more than 30 μm, decrease in a magnetic flux density distribution in magnetic gaps is not negligible, when assembled in magnet appliances, because the non-magnetic resin coating is too thick.

[5] Coupling Agent

Coupling agents applied to the chemical conversion layer before forming the resin coating may be coupling agents of aluminum, zirconium, iron, tin, etc.; (a) titanate coupling agents such as isopropyltriisostearoyl titanate, isopropyl-tri(N-aminoethyl-aminoethyl) titanate, isopropyl-tris(dioctylpyrophosphate) titanate, or isopropyltrioctanoyl titanate, etc., (b) silane coupling agents such as γ-aminopropyltriethoxysilane, N-β-(aminoethyl)-γ-aminopropyltrimethoxysilane, γ-glycidoxypropyltrimethoxysilane, β-(3,4-epoxy-cyclohexyl) ethyltrimethoxysilane, vinyltriethoxysilane, vinyltrimethoxysilane, vinyl-tris(2-methoxyethoxy)silane, diphenyldimethoxysilane, γ-methacryloxypropyltrimethoxysilane, 3-chloropropyltlimethoxysilane, or 3-mercaptopropyltrimethoxysilane, etc., (c) acetoalkoxy aluminum dilsopropylate, etc.

There are two methods for surface-treating the chemical conversion layer-coated R-T-B magnet with a coupling agent. (1) The amount of a coupling agent corresponding to 1-5 times the total surface area of the chemical conversion layer-coated R-T-B magnet is determined from the minimum coating area of the coupling agent. Next, a silane coupling agent in a necessary amount is diluted with a solvent such as ethanol. The chemical conversion layer-coated R-T-B magnet is immersed in this diluted solution, heated to about 50-60° C. while evacuating by a vacuum pump, to evaporate the solvent, and then cooled to obtain a coupling agent coating formed on the surface of the chemical conversion layer. (2) 0.05-5 parts by weight of a coupling agent is mixed with 99.95-95 parts by weight of a coating resin by a mixer, and the resultant mixture is coated onto the chemical conversion layer-coated R-T-B magnet, to form a coupling agent coating in an interface between the chemical conversion layer and the resin coating.

Incidentally, when the amount of the coupling agent is less than the lower limit in (1) and (2), there is no effect of improving corrosion resistance and a thermal demagnetization ratio. On the other hand, when it exceeds the upper limit, a brittle coupling agent coating is formed, resulting in drastic deterioration of corrosion resistance and a thermal demagnetization ratio.

The present invention will be described in detail referring to Examples below without intention of limiting the present invention thereto.

### EXAMPLE 1

Rectangular, thin, plate-shaped R-T-B sintered magnets for CD pickups having a length of 5 mm, a width of 5 mm and a thickness of 1 mm (with anisotropy in their thickness directions) with a main component composition comprising 26.2% by weight of Nd, 5.0% by weight of Pr, 0.8% by weight of Dy, 0.97% by weight of B, 3.0% by weight of Co, 0.1% by weight of Al, 0.1% by weight of Ga, 0.1% by weight of Cu, and 63.73% by weight of Fe were subjected to ultrasonic cleaning in water. The magnets in Groups A-D shown in Table 1 were pretreated with an aqueous sulfuric acid solution at a concentration of 1% by volume, and those in Group E were pretreated with an aqueous alkaline solution containing 50 g/L of sodium hydroxide and 50 g/L of sodium carbonate. However, the in Group F were not pretreated. Next, each magnet was to a chemical conversion treatment in a chemical conversion solution under immersion conditions both shown in Table 1.

TABLE 1

| | | | | | | | Chemical | |
|---|---|---|---|---|---|---|---|---|
| | | | | | (Mo/P) | | Conversion | Corrosion |
| Test | | H₃PO₄* | H₂O | Na₂MoO₄ · | (molar | | Treatment | Resistance |
| No. | | (mL) | (mL) | 2H₂O (g) | ratio) | pH | Conditions | Test Results |
| A | 1 | 5.0 | 295.0 | 0 | 0 | 1.44 | 40° C. × 10 | X |
| | | | | | | | minutes | |
| | 2 | 5.0 | 295.0 | 5.0 | 0.282 | 1.98 | 40° C. × 10 | X |
| | | | | | | | minutes | |
| | 3 | 5.0 | 295.0 | 10.0 | 0.564 | 3.09 | 40° C. × 10 | ◯ |
| | | | | | | | minutes | |
| | 4 | 5.0 | 295.0 | 15.0 | 0.846 | 5.78 | 40° C. × 10 | ◯ |
| | | | | | | | minutes | |
| | 5 | 5.0 | 295.0 | 20.0 | 1.128 | 6.37 | 40° C. × 10 | X |
| | | | | | | | minutes | |
| B | 6 | 2.5 | 297.5 | 10.0 | 1.128 | 6.02 | 40° C. × 10 | X |
| | | | | | | | minutes | |
| | 7 | 5.0 | 295.0 | 10.0 | 0.564 | 3.09 | 40° C. × 10 | ◯ |
| | | | | | | | minutes | |
| | 8 | 7.5 | 292.5 | 10.0 | 0.376 | 2.02 | 40° C. × 10 | ◯ |
| | | | | | | | minutes | |
| | 9 | 10.0 | 290.0 | 10.0 | 0.282 | 1.75 | 40° C. × 10 | X |
| | | | | | | | minutes | |
| C | 10 | 2.5 | 297.5 | 5.0 | 0.564 | 3.98 | 40° C. × 10 | ◯ |
| | | | | | | | minutes | |
| | 11 | 5.0 | 295.0 | 10.0 | 0.564 | 3.09 | 40° C. × 10 | ◯ |
| | | | | | | | minutes | |
| | 12 | 7.5 | 292.5 | 15.0 | 0.564 | 3.03 | 40° C. × 10 | ◯ |
| | | | | | | | minutes | |
| | 13 | 10.0 | 290.0 | 20.0 | 0.564 | 2.86 | 40° C. × 10 | ◯ |
| | | | | | | | minutes | |
| D | 14 | 5.0 | 295.0 | 10.0 | 0.564 | 3.09 | 60° C. × 10 | ◯ |
| | | | | | | | minutes | |
| | 15 | 5.0 | 295.0 | 10.0 | 0.564 | 3.09 | 60° C. × 60 | ◯ |
| | | | | | | | minutes | |
| E | 16 | 5.0 | 295.0 | 10.0 | 0.564 | 3.09 | 60° C. × 10 | ◯ |
| | | | | | | | minutes | |
| F | 17 | 5.0 | 295.0 | 10.0 | 0.564 | 3.09 | 60° C. × 10 | ◯ |
| | | | | | | | minutes | |

Note *Added as an aqueous solution of 85% by weight H₃PO₄.

In Table 1, Sample Nos. 1-5 in Group A are R-T-B magnets coated with chemical conversion layers obtained with an aqueous phosphoric acid solution at a constant concentration of 1.4% by weight and with the changed amounts of a molybdate, Sample Nos. 6-9 in Group B are R-T-B magnets coated with chemical conversion layers obtained with a molybdate in a constant amount of 10 g and the changed concentrations of phosphoric acid, Sample Nos. 10-13 in Group C are R-T-B magnets coated with chemical conversion layers obtained with a constant molar ratio (Mo/P) of 0.564 and the changed amounts of phosphoric acid and molybdate, Sample Nos. 14, 15 in Group D are R-T-B magnets coated with chemical conversion layers obtained with the changed immersion temperature and time of the chemical conversion treatment solution, using the amounts of phosphoric acid and molybdate in Sample Nos. 3, 7 and 11, which were appreciated to have good corrosion resistance among the above Groups A, B and C.

Corrosion resistance was evaluated by introducing each R-T-B magnet coated with a chemical conversion layer into a constant-temperature, constant-humidity chamber filled with the air, keeping it at a temperature of 60° C. and a relative humidity of 90% for 200 hours, returning it to room temperature and then observing its appearance by the naked eye. The evaluation standards are as follows:

X: Rust (red rust) was generated.

◯: Good appearance was kept.

As a result of analysis by SEM-EDX (type S2300, available from Hitachi, Ltd.), any chemical conversion layers contained a large amount of phosphorus in addition to molybdenum. Incidentally, sodium was not detected in the chemical conversion layers. Because a ratio of iron to neodymium in the substrate detected by the SEM-EDX analysis differed depending on the compositions of the chemical conversion treatment solutions, it was found that the chemical conversion layers contained substrate components dissolved away from the R-T-B magnets.

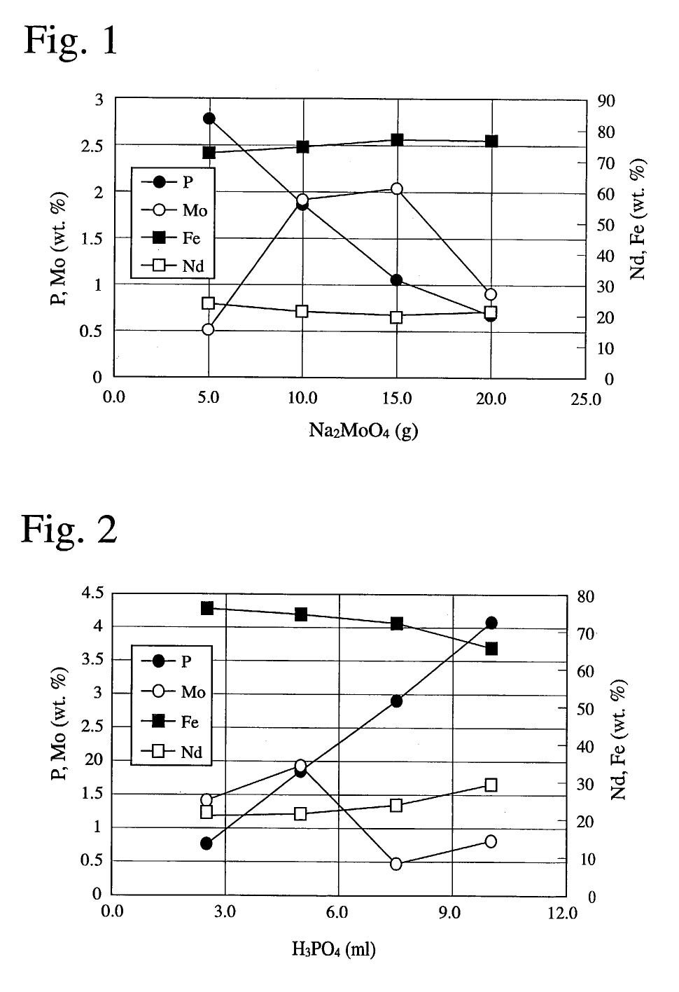

The chemical conversion layers of Sample Nos. 2-5 obtained by changing the amount of a molybdate compound with phosphoric acid at a constant concentration of 1.4% by weight were analyzed by SEM-EDX. The change of the amounts of molybdenum, phosphorus, iron and neodymium detected are shown in FIG. 1. It was found from FIG. 1 and Table 1 that when the amount of sodium molybdate was in a range of 10-15 g (molar ratio Mo/P: 0.654-0.846), the chemical conversion layer contained a large amount of molybdenum, thereby exhibiting excellent corrosion resistance.

It has been found from the above results that in the chemical conversion treatment using a molybdate, (a) the higher the temperature of the chemical conversion treatment solution, the better corrosion resistance the resultant chemical conversion layer has; (b) the longer the immersion time, the better corrosion resistance the resultant chemical conversion layer has; and (c) when acid is not used in pretreatment, the resultant chemical conversion layer has better corrosion resistance.

FIG. 2 shows the analysis results of the surfaces of chemical conversion layers by SEM-EDX in Sample Nos. 6-9 having chemical conversion layers obtained by changing the concentration of phosphoric acid with the amount of molybdate kept constant at 10 g. It is clear from FIG. 2 that though the amount of phosphorus increases as the concentration of phosphoric acid increases, the amount of molybdenum is maximum when the chemical conversion treatment solution has a molar ratio Mo/P of 0.564.

It is clear from the results of Table 1 and FIGS. 1 and 2 that the most preferable composition of the chemical conversion treatment solution is obtained by adding molybdate to an aqueous phosphoric acid solution at a concentration of 1.4% by weight such that the molar ratio Mo/P is 0.564.

### EXAMPLES 2, 3, REFERENCE EXAMPLE 1, COMPARATIVE EXAMPLES 1-6

The same rectangular, thin, plate-shaped R-T-B sintered magnets having a length of 5 mm, a width of 5 mm and a thickness of 1 mm (with anisotropy in their thickness directions) for CD pickups as in Example 1 were subjected to ultrasonic cleaning in water. Each magnet was subjected to either one of the following pretreatments (a)-(d).

Pretreatment (a): Cleaning with an aqueous solution containing 1% by volume of sulfuric acid,

Pretreatment (b): Cleaning with an aqueous solution containing 1.0% by weight of sodium nitrate and 0.5% by weight of sulfuric acid,

Pretreatment (c): Cleaning with an aqueous solution containing 1.7% by weight of titanium potassium fluoride (available from Kanto Kagagu K. K.), and

Pretreatment (d): Cleaning with an aqueous alkaline solution containing 50 g/L of sodium hydroxide and 50 g/L of sodium carbonate.

Used in a chemical conversion treatment I was a chemical conversion treatment solution containing sodium molybdate such that the concentration of phosphoric acid was 1.4% by weight, the molar ratio (Mo/P) was 0.564, and the pH was 3.09. Also, used in a chemical conversion treatment II was a chemical conversion treatment solution obtained by adding 1% by volume of nitric acid (reaction accelerator) to the chemical conversion treatment solution of I. Each chemical conversion treatment I, II was carried out by immersing the R-T-B sintered magnets in the chemical conversion treatment solution at 60° C. for 10 minutes.

TABLE 2

| | | | Demagnetiza- | Thermal | Corrosion |
|---|---|---|---|---|---|
| No./ | | | tion Ratio | Demagnetization | Resistance |
| Sample No. | | Treatment Method | (%) | Ratio (%) | Test Results |
| Ref | 21 | Substrate* | 0 | 4.25 | X |
| Ex. 1 | 22 | Pretreatment (a) | 3.60 | 5.24 | X |
| | 23 | Pretreatment (b) | 1.74 | 4.07 | X |
| | 24 | Pretreatment (c) | 1.50 | 4.77 | X |
| | 25 | Pretreatment (d) | 0 | 4.20 | X |
| Ex. 2 | 26 | Chemical Conversion | 1.17 | 3.61 | ◯ |
| | | Treatment I | | | |
| Com. | 27 | Pretreatment (a) + | | | |
| Ex. 1 | | Chemical Conversion | 3.76 | 7.11 | ◯ |
| | | Treatment I | | | |
| Com. | 28 | Pretreatment (c) + | | | |
| Ex. 2 | | Chemical Conversion | 2.40 | 5.22 | X |
| | | Treatment I | | | |
| Ex. 3 | 29 | Pretreatment (d) + | | | |
| | | Chemical Conversion | 1.20 | 3.72 | ◯ |
| | | Treatment I | | | |
| Com. | 30 | Chemical Conversion | 1.42 | 5.39 | ◯ |
| Ex. 3 | | Treatment II | | | |
| Com. | 31 | Pretreatment (a) + | | | |
| Ex. 4 | | Chemical Conversion | 7.03 | 8.80 | ◯ |
| | | Treatment II | | | |
| Com. | 32 | Pretreatment (c) + | | | |
| Ex. 5 | | Chemical Conversion | 2.08 | 5.52 | X |
| | | Treatment II | | | |
| Com. | | Chromate Treatment | 1.00 | 3.90 | ◯ |
| Ex. 6 | | | | | |

Note *Substrate means an R-T-B magnet subjected to neither pretreatment nor chemical conversion treatment.

The demagnetization ratio shown in Table 2 means a decrease ratio of the total magnetic flux Φ₂ of each R-T-B magnet substrate after the chemical conversion treatment to the total magnetic flux Φ₁ of each R-T-B magnet substrate before the chemical conversion treatment (before the pretreatment when it was carried out), which was determined by the following equation:

Demagnetization ratio=[(Φ₁−Φ₂)/Φ₁]×100 (%).

The thermal demagnetization ratio means a demagnetization ratio of the resultant chemical conversion layer-coated R-T-B magnet by thermal hysteresis, which was determined from the total magnetic flux Φ′₁ of each chemical conversion layer-coated R-T-B magnet which was magnetized at room temperature under saturation conditions and the total magnetic flux Φ′₂ of each chemical conversion layer-coated R-T-B magnet which was heat-treated at 85° C. for 2 hours in the air, cooled to room temperature and then magnetized under saturation conditions, by the following equation:

Thermal demagnetization ratio=[(Φ′₁−Φ′₂)/Φ′₁]×100 (%).

It is clear from Table 2 that Samples (R-T-B magnets coated with Mo chemical conversion layers) of Examples 2 and 3 had a demagnetization ratio close to that of the conventional chromate chemical conversion layer-coated R-T-B magnets and a thermal demagnetization ratio higher than that of the conventional chromate-coated R-T-B magnets, in addition to good corrosion resistance.

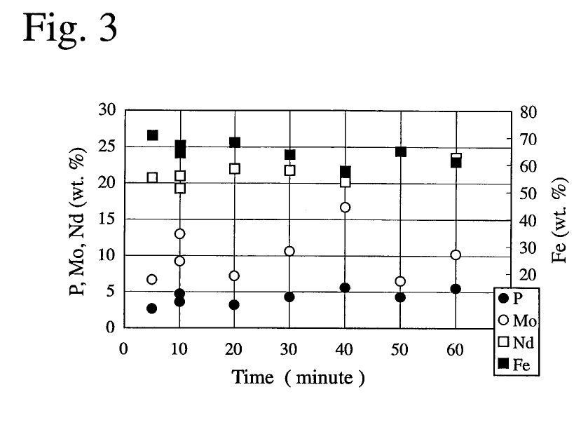

FIG. 3 shows the relations between immersion time and the components of the chemical conversion layer obtained by SEM-EDX analysis, with respect to R-T-B magnets coated with chemical conversion layers produced by the same chemical conversion treatment as in Sample No. 16 except that the immersion time was 5-60 minutes. As the immersion time increased, phosphorus increased. Also, neodymium tended to increase slowly, presumably because neodymium dissolved away from the magnet substrates was incorporated into the chemical conversion layers.

The thickness of the chemical conversion layer of the chemical conversion layer-coated R-T-B magnet obtained in Example 3 was measured by X-ray photoelectron spectroscopy (XPS) using an X-ray photoelectron spectroscope [ESCA-850, available from Shimadzu Corp.]. As a result, the thickness of the chemical conversion layer was about 12 nm (average value).

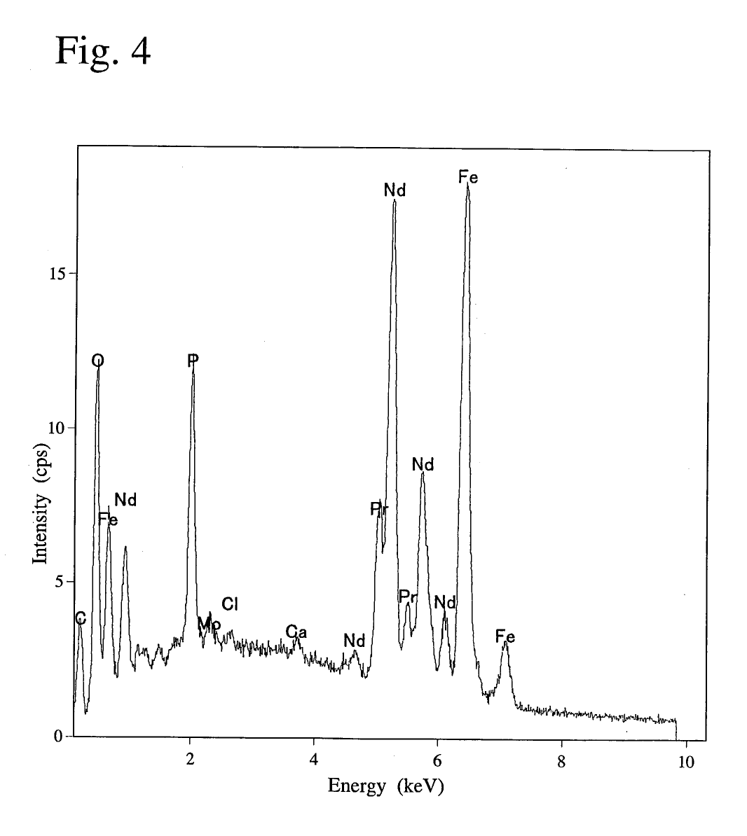

The surface of the chemical conversion layer of the chemical conversion layer-coated R-T-B magnet obtained in Example 3 was analyzed by SEM-EDX [S2300, available from Hitachi Ltd.]. The results are shown in FIG. 4, in which the axis of abscissas indicates a detected X-ray energy distribution (keV), and the axis of ordinates indicates a count number [c.p.s. (count per second)]. Because a profile of Fe by the R-T-B magnet substrate appeared in FIG. 4, Fe should be excluded when determining the composition of the chemical conversion layer. As a result, it was found that the chemical conversion layer formed on the R-T-B magnet surface contained 0, P, Nd, Pr and a trace amount of Mo. Incidentally, C, Cl and Ca appearing in FIG. 4 were inevitable impurities.

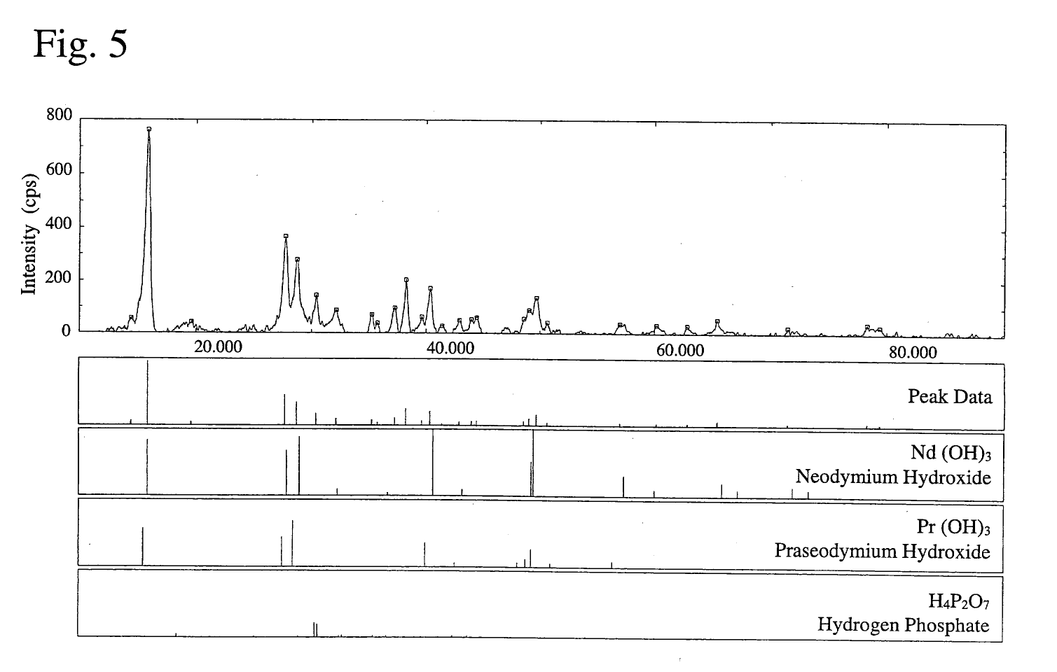

A chemical conversion layer portion of the chemical conversion layer-coated R-T-B magnet obtained in Example 3 was subjected to X-ray diffraction by a thin-film X-ray diffraction apparatus (RINT 2500V using CuKα1 line, available from Rigaku Denki K. K.). The results are shown in FIG. 5, in which the axis of abscissas indicates a diffraction angle [2θ (°)], and the axis of ordinates indicates the count number (c.p.s) of X-ray. It is clear from FIG. 5 that the main phase of the chemical conversion layer was composed of pyrophosphoric acid (H₄P₂O₇), Nd(OH)₃ and Pr(OH)₃.

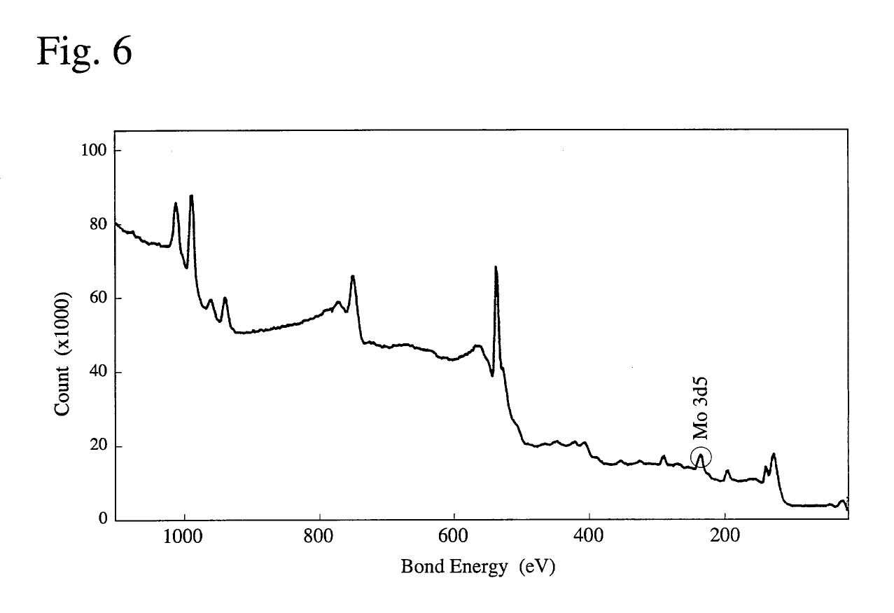

The surface of the chemical conversion layer-coated R-T-B magnet obtained in Example 3 was analyzed by ESCA (MICROLAB 310-D, available from VG Scientific). The results are shown in FIG. 6, in which the axis of ordinates indicates the count number (arbitrary unit), and the axis of abscissas indicates bond energy of electrons. It was found from the peak of Mo3d5 in FIG. 6 that Mo in the chemical conversion layer was in a bond state of MoO₂.

It is considered from the results of FIGS. 4-6 that the chemical conversion layer of the chemical conversion layer-coated R-T-B magnet in Example 3 is substantially composed of pyrophosphoric acid, a hydroxide of R and amorphous MoO₂.

### EXAMPLE 4

An epoxy group-containing silane coupling agent (3-glycidoxypropyltrimethoxysilane, minimum coating area 331 m²/g) in an amount corresponding to 1.2 times the total surface area of the chemical conversion layer-coated R-T-B magnet obtained in Example 3 was diluted with 30 cc of ethanol to prepare a surface treatment solution. The chemical conversion layer-coated R-T-B magnet obtained in Example 3 was immersed in this surface treatment solution, heated to 50° C. to evaporate ethanol while evacuating by a vacuum pump, and then cooled to form a silane coupling agent coating.

The resultant R-T-B magnet having a chemical conversion layer and a silane coupling agent coating was coated with an epoxy resin coating having an average thickness of 20 μm by an electrodeposition method. The resultant epoxy resin-coated magnet was introduced into a constant-temperature, constant-humidity chamber, in which it was kept at a temperature of 60° C. and a relative humidity of 90% for 400 hours in the air and then cooled to room temperature. Sample thus obtained had good appearance and corrosion resistance.

### COMPARATIVE EXAMPLE 7

The chemical conversion layer-coated R-T-B magnet obtained in Example 3 was provided with an epoxy resin coating having an average thickness of 20 μm by an electrodeposition method without surface treatment with a silane coupling agent. The resultant epoxy resin-coated magnet was introduced into a constant-temperature, constant-humidity chamber, in which it was kept at a temperature of 60° C. and a relative humidity of 90% for 400 hours in the air and then returned to room temperature. As a result of observing the surface of Sample thus obtained, it was found that it had blisters with partial rust (red rust).

### EXAMPLE 5

The same R-T-B magnet having a chemical conversion layer and a silane coupling agent coating as in Example 4 was provided with a polyparaxylylene resin coating having an average thickness of 7 μm by a vapor deposition method. The resultant polyparaxylylene resin-coated magnet was introduced into a constant-temperature, constant-humidity chamber, in which it was kept at a temperature of 60° C. and a relative humidity of 90% for 400 hours in the air and returned to room temperature. Sample thus obtained had good appearance and corrosion resistance.

### COMPARATIVE EXAMPLE 8

The chemical conversion layer-coated R-T-B magnet obtained in Example 3 was provided with a polyparaxylylene resin coating having an average thickness of 7 μm by a vapor deposition method without surface treatment with a silane coupling agent. The resultant polyparaxylylene resin-coated magnet was introduced into a constant-temperature, constant-humidity chamber, in which it was kept at a temperature of 60° C. and a relative humidity of 90% for 400 hours in the air and then returned to room temperature. As a result of observing the surface of Sample thus obtained, it was found that it had blisters with partial rust (red rust).

### EXAMPLE 6-11, COMPARATIVE EXAMPLE 9-11

Flat, ring-shaped R-T-B sintered magnets having an outer diameter of 20 mm, an inner diameter of 10 mm and a thickness of 0.8 mm (with anisotropy in their thickness directions) with a main component composition comprising 26.2% by weight of Nd, 5.0% by weight of Pr, 0.8% by weight of Dy, 0.97% by weight of B, 3.0% by weight of Co, 0.1% by weight of Al, 0.1% by weight of Ga, 0.1% by weight of Cu, and 63.73% by weight of Fe were subjected to ultrasonic cleaning in water. Each magnet was pretreated with an aqueous alkaline solution containing 50 g/L of sodium hydroxide and 50 g/L of sodium carbonate, and then subjected to a chemical conversion treatment in a chemical conversion treatment solution under chemical conversion treatment conditions both shown in Table 3.

Each Sample of the resultant chemical conversion layer-coated R-T-B magnets was introduced into a constant-temperature, constant-humidity chamber, in which it was kept at a temperature of 60° C. and a relative humidity of 90% for 400 hours in the air and then returned to room temperature. Each chemical conversion layer-coated Sample was measured with respect to a thermal demagnetization ratio in the same manner as in Example 2. Also, the appearance of each chemical conversion layer-coated Sample was observed by the naked eye, to evaluate corrosion resistance A shown in Table 3 by the following standards:

X: Rust (red rust) was observed, and

◯: Showed good appearance.

Next, each Sample of the chemical conversion layer-coated R-T-B magnet was electrodeposited with an epoxy resin at an average thickness of 20 μm. It was tested by a PCT (PC-422R, available from Hirayama Manufacturing Corp.) in the atmosphere at 120° C., 100% RH and pressure of 2 atm for 12 hours, and then returned to the air at room temperature. The appearance of each chemical conversion layer / epoxy resin-coated Sample was observed by the naked eye, to evaluate corrosion resistance B shown in Table 3 by the following standards:

X: Rust (red rust) was observed, and

◯: Showed good appearance.

The chemical conversion layer/epoxy resin-coated R-T-B magnet of Sample No. 68 was measured with respect to a thermal demagnetization ratio in the same manner as in Example 2. It was thus found that the thermal demagnetization ratio was 3.3%. Incidentally, Sample No. 84 is a flat, ring-shaped R-T-B sintered magnet provided with a conventional chromate coating formed by a chromic acid treatment.

TABLE 3

| | | Phosphoric | Sodium | Molar | Immersion | |
|---|---|---|---|---|---|---|
| No./Sample | | Acid* | Molybdate | Ratio | Conditions | |
| No. | | (mL/L) | (g/L) | (Mo/P) | (° C. × minutes) | pH |
| Ex. 6 | 57 | 0.07 | 3.68 | 12.00 | RT** × 10 | 5.0 |
| | 58 | 0.07 | 4.68 | 15.26 | RT × 10 | 5.0 |
| | 59 | 0.07 | 6.18 | 20.15 | RT × 10 | 5.0 |
| | 60 | 0.07 | 8.68 | 28.29 | RT × 10 | 5.0 |
| | 61 | 0.07 | 11.18 | 36.44 | RT × 10 | 5.0 |
| | 62 | 0.07 | 13.68 | 44.59 | RT × 10 | 5.0 |
| Com. | 63 | 0.07 | 8.68 | 28.29 | RT × 10 | 3.5 |
| Ex. 9 | 64 | 0.07 | 8.68 | 28.29 | RT × 10 | 4.0 |
| Ex. 7 | 65 | 0.07 | 8.68 | 28.29 | RT × 10 | 4.5 |
| | 66 | 0.07 | 8.68 | 28.29 | RT × 10 | 5.0 |
| | 67 | 0.07 | 8.68 | 28.29 | RT × 10 | 5.5 |
| | 68 | 0.07 | 8.68 | 28.29 | RT × 10 | 6.0 |
| Ex. 8 | 69 | 0.07 | 8.68 | 28.29 | RT × 5 | 5.0 |
| | 70 | 0.07 | 8.68 | 28.29 | RT × 8 | 5.0 |
| | 71 | 0.07 | 8.68 | 28.29 | RT × 10 | 5.0 |
| | 72 | 0.07 | 8.68 | 28.29 | RT × 12 | 5.0 |
| Ex. 9 | 73 | 0.07 | 8.68 | 28.29 | RT × 10 | 5.0 |
| | 74 | 0.07 | 8.68 | 28.29 | 40 × 10 | 5.0 |
| Ex. 10 | 75 | 0.07 | 3.68 | 12.00 | RT × 3 | 4.2 |
| | 76 | 0.07 | 3.68 | 12.00 | RT × 10 | 4.2 |
| Com. | 77 | 0.07 | 3.68 | 12.00 | RT × 10 | 6.5 |
| Ex. 10 | | | | | | |
| Ex. 11 | 78 | 0.02 | 6.23 | 60.88 | RT × 10 | 5.0 |
| | 79 | 0.05 | 7.45 | 36.44 | RT × 10 | 5.0 |
| | 80 | 0.07 | 8.68 | 28.29 | RT × 10 | 5.0 |
| | 81 | 0.10 | 9.91 | 24.22 | RT × 10 | 5.0 |
| | 82 | 0.12 | 11.14 | 21.78 | RT × 10 | 5.0 |
| | 83 | 0.15 | 12.36 | 20.15 | RT × 10 | 5.0 |

| | | |
|---|---|---|
| Com. | 84 | Chromate Treatment |
| Ex. 11 | | |

| | | | | Thermal |
|---|---|---|---|---|
| No./Sample | | Corrosion | Corrosion | Demagnetization |
| No. | | Resistance A | Resistance B | Ratio (%) |
| Ex. 6 | 57 | ◯ | ◯ | 3.5 |
| | 58 | ◯ | ◯ | 3.5 |
| | 59 | ◯ | ◯ | 3.5 |
| | 60 | ◯ | ◯ | 3.5 |
| | 61 | ◯ | ◯ | 3.5 |
| | 62 | ◯ | ◯ | 3.5 |
| Com. | 63 | ◯ | ◯ | 4.1 |
| Ex. 9 | 64 | ◯ | ◯ | 4.0 |
| Ex. 7 | 65 | ◯ | ◯ | 3.5 |
| | 66 | ◯ | ◯ | 3.5 |
| | 67 | ◯ | ◯ | 3.5 |
| | 68 | ◯ | ◯ | 3.4 |
| Ex. 8 | 69 | ◯ | ◯ | 3.5 |
| | 70 | ◯ | ◯ | 3.5 |
| | 71 | ◯ | ◯ | 3.5 |
| | 72 | ◯ | ◯ | 3.5 |
| Ex. 9 | 73 | ◯ | ◯ | 3.5 |
| | 74 | ◯ | ◯ | 3.5 |
| Ex. 10 | 75 | ◯ | ◯ | 3.7 |
| | 76 | ◯ | ◯ | 3.7 |
| Com. | 77 | X | X | 4.3 |
| Ex. 10 | | | | |
| Ex. 11 | 78 | ◯ | ◯ | 3.5 |
| | 79 | ◯ | ◯ | 3.5 |
| | 80 | ◯ | ◯ | 3.5 |
| | 81 | ◯ | ◯ | 3.5 |
| | 82 | ◯ | ◯ | 3.5 |
| | 83 | ◯ | ◯ | 3.4 |
| Com. | 84 | ◯ | ◯ | 3.9 |
| Ex. 11 | | | | |

Note *Added as an aqueous solution of 85% by weight of H₃PO₄.
**Room temperature.

Sample Nos. 57-62 were subjected to a chemical conversion treatment by using a chemical conversion treatment solution containing phosphoric acid and sodium molybdate and having pH controlled to 5 by adding an aqueous solution of 50 g/L of sodium hydroxide or an aqueous solution of 50 mL/L of nitric acid. These Samples were measured with respect to corrosion resistance B. It was thus found that though good appearance was kept until 12 hours passed, there was observed more surface roughness (small roughness) in Samples obtained with a smaller amount of sodium molybdate after the test for 36 hours by PCT. This revealed that the addition of sodium molybdate improved the corrosion resistance of the chemical conversion layers.

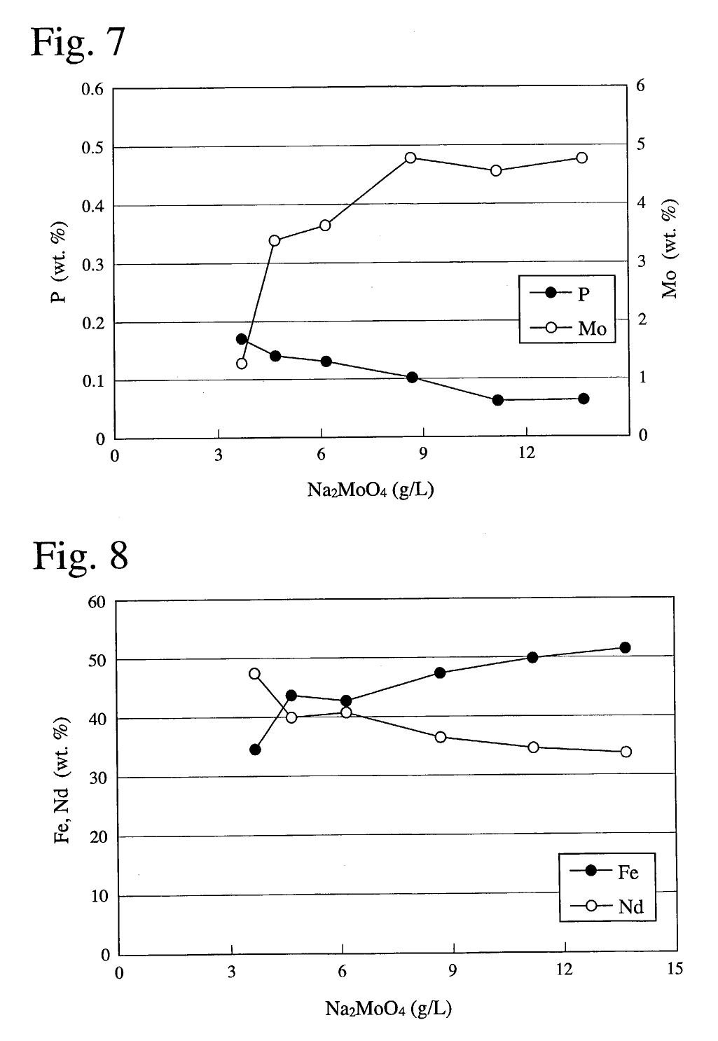

FIGS. 7 and 8 are graphs in which the analysis results of the chemical conversion layers of Sample Nos. 57-62 by SEM-EDX are plotted against the amount of sodium molybdate. FIG. 7 shows the analysis results of phosphorus and molybdenum, and FIG. 8 shows the analysis results of iron and neodymium. A trace amount of phosphorus was contained in the chemical conversion layers, and the amount of phosphorus tended to decrease as the amount of sodium molybdate increased. On the other hand, the amount of molybdenum detected was extremely larger than the amount of phosphorus detected, and increased as the amount of sodium molybdate increased.

Sample Nos. 63-68 are R-T-B magnets coated with chemical conversion layers obtained by immersion in chemical conversion treatment solutions containing 0.07 mL/L of phosphoric acid and 8.68 g/L of sodium molybdate and having pH controlled by adding nitric acid or sodium hydroxide, under the chemical conversion treatment conditions of room temperature (25±3° C.) for 10 minutes. These Samples were excellent in both of corrosion resistance A and B with no red rust observed. Incidentally, in Samples for the corrosion resistance B test after subjected to 36 hours of the PCT test, surface roughness was more remarkable as the pH of the chemical conversion treatment solution became higher.

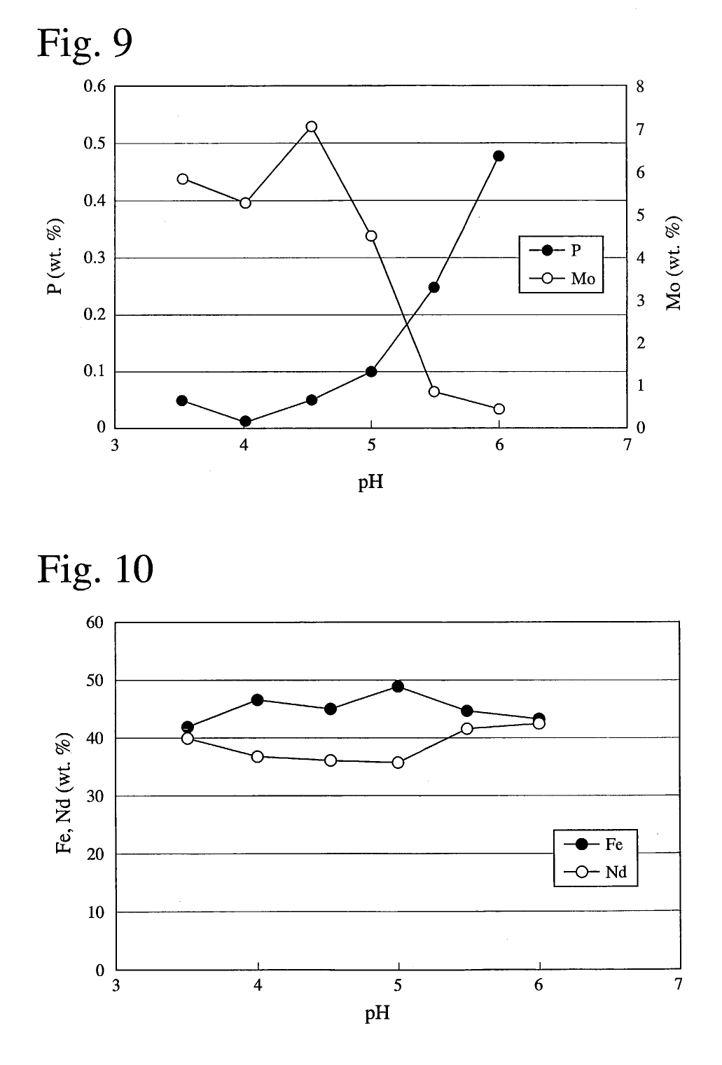

The analysis results of the chemical conversion layers of Sample Nos. 63-68 by SEM-EDX are shown in FIGS. 9 and 10. The amount of phosphorus increased with pH. On the other hand, it was found that molybdenum drastically decreased at pH near 5.5 correspondingly to decrease in the thickness of the chemical conversion layer. As a result of measuring the average thickness of the chemical conversion layers of Sample Nos. 63-68 by the same method as for measuring the layer thickness of the chemical conversion layer-coated magnets of Example 3, Sample No. 63 was 17 nm, Sample No. 64 was 15 nm, Sample No. 65 was 20 nm, Sample No. 66 was 13 nm, Sample No. 67 was 4 nm, and Sample No. 68 was 3 nm.

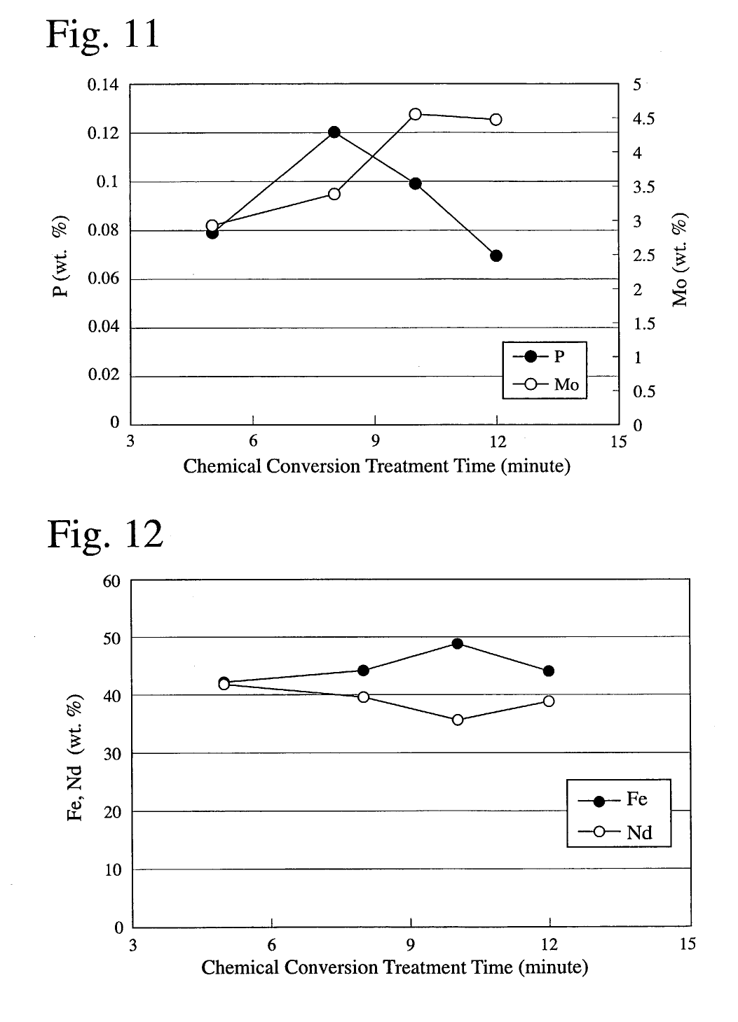

Sample Nos. 69-72 were examined with respect to the change of chemical conversion layer surfaces with the chemical conversion treatment time. As a result, any Samples had good corrosion resistance A, B. In Samples after 36 hours of the PCT test, the shorter the chemical conversion treatment time, the slightly more remarkable the surface roughness tended to be. The analysis results of the chemical conversion layers of Sample Nos. 69-72 by SEM-EDX are shown in FIGS. 11 and 12. It was found that as the chemical conversion treatment time increased, the amount of molybdenum attached increased.

Sample Nos. 73 and 74 were examined with respect to the influence of the chemical conversion treatment temperature on the surfaces of the resultant chemical conversion layers. The analysis results of the surfaces of the chemical conversion layers by SEM-EDX revealed that the amount of molybdenum attached was 4.57% by weight at room temperature (25° C.), 5.78% by weight at 40° C., indicating that the higher the chemical conversion treatment temperature, the thicker the chemical conversion layers.

Sample Nos. 75-77 were examined with respect to the relations between the corrosion resistance of the chemical conversion layer-coated R-T-B magnets and the pH of the chemical conversion treatment solutions. The pH of the chemical conversion treatment solutions was controlled by adding sodium hydroxide. At pH of 6.5, the chemical conversion layer surfaces suffered from red rust, poor in corrosion resistance.

Sample Nos. 78-83 are samples formed with chemical conversion layers by using chemical conversion treatment solutions having pH kept constant at 5.0 by adding nitric acid or sodium hydroxide to each chemical conversion treatment solution, the amounts of phosphoric acid and sodium molybdate being randomly changed. Any Samples had chemical conversion layers with good corrosion resistance A, B and appearance. In Samples after 36 hours of the test by PCT, the smaller the amount of sodium molybdate, the more surface roughness the resultant chemical conversion layers tended to have.

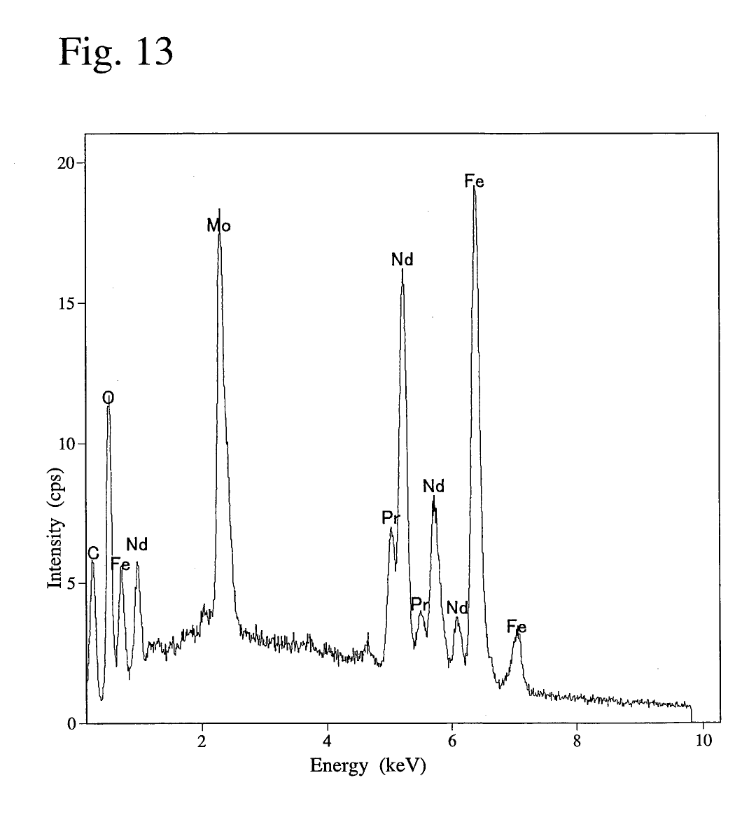

The chemical conversion layer surface of Sample No. 68 (Example 7) was analyzed by SEM-EDX in the same manner as in Example 3. The results are shown in FIG. 13. There was not a peak of P but a peak of Mo observed in FIG. 13. This revealed that except for the profile of Fe by the R-T-B magnet substrate, main components of the chemical conversion layer were O, Mo, Nd and Pr. C is an inevitable impurity in FIG. 13.

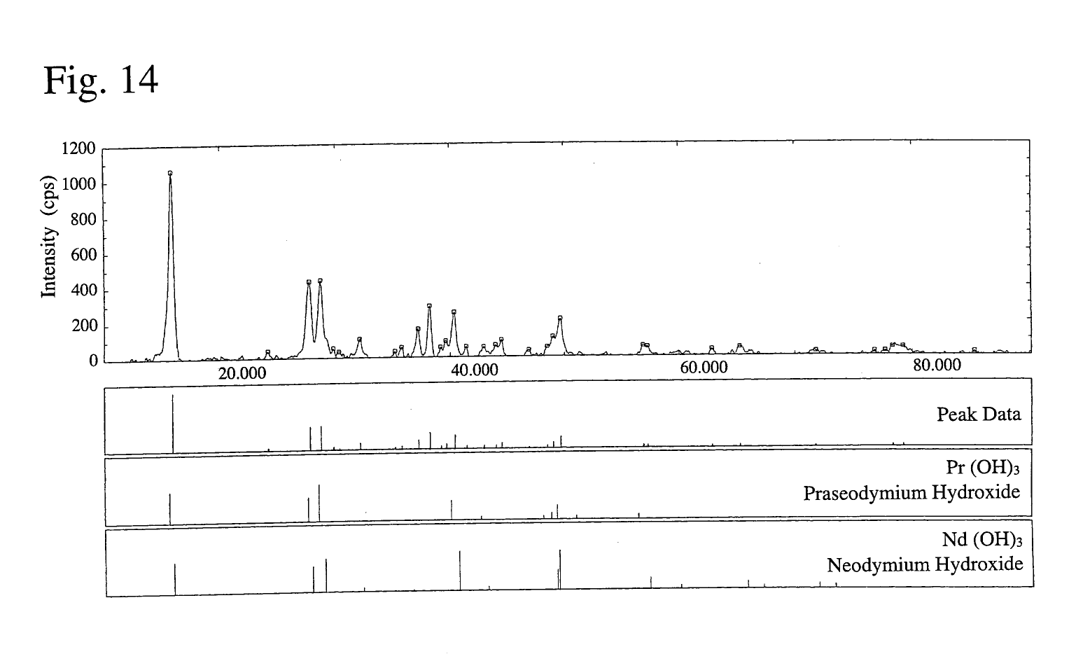

The chemical conversion layer of Sample No. 68 was measured with respect to X-ray diffraction (CuKα1) in the same manner as in Example 3. The results are shown in FIG. 14. It was found from FIG. 14 that Nd(OH)₃ and Pr(OH)₃ were formed in the chemical conversion layer.

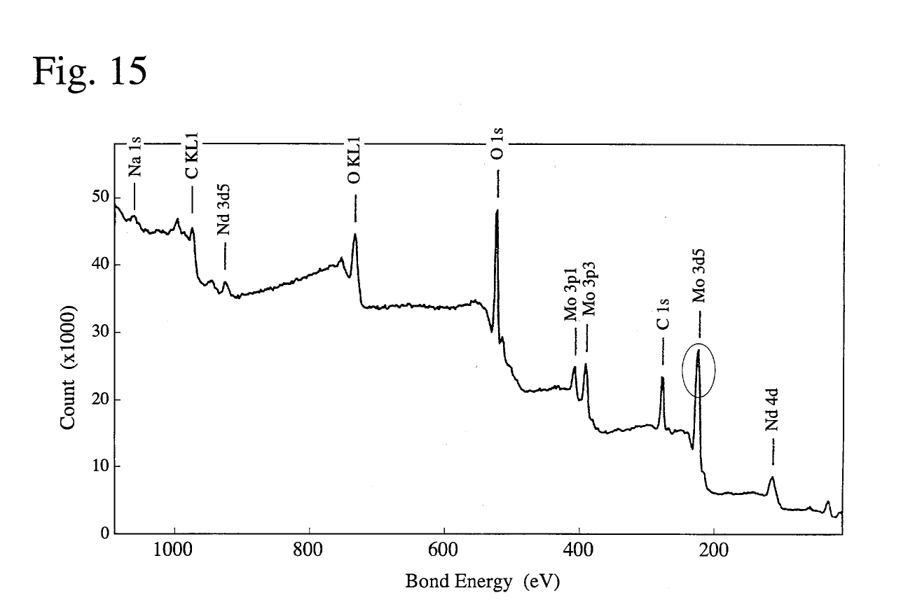

The chemical conversion layer surface of Sample No. 68 was analyzed by ESCA in the same manner as in Example 3. The results are shown in FIG. 15. It was found from FIG. 15 that Mo existed in the form of MoO₂.

It was found from FIGS. 13, 14 and 15 that the chemical conversion layer formed on the R-T-B magnet of Sample No. 68 was substantially composed of amorphous MoO₂, Nd(OH)₃ and Pr(OH)₃.

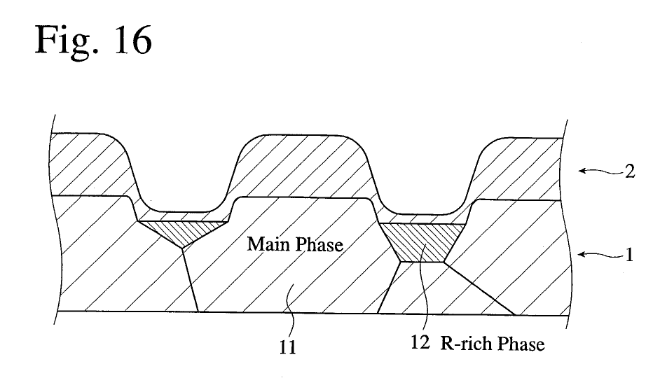

FIG. 16 schematically shows the cross section of the chemical conversion layer-coated R-T-B magnet 1 of Sample No. 68. It was observed that the chemical conversion layer 2 tended to be thick on the main phase 11 and thin on the R-rich phase 12.

### EXAMPLE 12

The chemical conversion layer-coated magnet of Sample No. 68 was provided with a silane coupling agent coating and further with a polyparaxylylene resin coating having an average thickness of 8 μm in the same manner as in Example 5. The resultant polyparaxylylene resin-coated magnet was introduced into a constant-temperature, constant-humidity chamber, in which it was kept at a temperature of 60° C. and a relative humidity of 90% for 400 hours in the air and then returned to room temperature. Sample thus obtained had good appearance and corrosion resistance. Also, the thermal demagnetization ratio measured in the same manner as in Example 2 was 3.1%.

### EXAMPLE 13

A polyparaxylylene resin coating was formed in the same manner as in Example 12 except for carrying out no surface treatment with a silane coupling agent on a chemical conversion layer. The resultant polyparaxylylene resin-coated magnet was introduced into a constant-temperature, constant-humidity chamber, in which it was kept at a temperature of 60° C. and a relative humidity of 90% for 400 hours in the air and then returned to room temperature. As a result of observing the surface of Sample thus obtained, it was confirmed that it had good appearance. Also, the thermal demagnetization ratio measured in the same manner as in Example 2 was 3.3%.

### EXAMPLE 14

The chemical conversion layer-coated magnet of Sample No. 68 was provided with a silane coupling agent coating in the same manner as in Example 12, and further with an epoxy resin coating having an average thickness of 19 μm by an electrodeposition method. The resultant epoxy resin-coated magnet was introduced into a constant-temperature, constant-humidity chamber, in which it was kept at a temperature of 60° C. and a relative humidity of 90% for 400 hours in the air and then returned to room temperature. Sample thus provided with a chemical conversion layer, a silane coupling agent coating and an epoxy resin layer had good appearance and corrosion resistance. Also, the thermal demagnetization ratio measured in the same manner as in Example 2 was 3.1%, indicating that it was improved in a thermal demagnetization ratio than the chemical conversion layer/epoxy resin-coated Sample No. 68 in Example 7.

Though thin, plate-shaped R-T-B magnets or flat, ring-shaped R-T-B magnets were used in the above Examples, the R-T-B magnets to which the present invention is applicable are not restricted thereto, but the present invention is effective for R-T-B magnets having radial anisotropy, polar anisotropy or radial two-polar anisotropy, etc. Though R-T-B sintered magnets were used in the above Examples, the same effects can be obtained for hot-worked R-T-B magnets, too. Further, when the R-T-B magnet is provided with the chemical conversion layer of the present invention via an electrolytic or electroless Ni plating having an average thickness of 0.5-20 μm, the corrosion resistance and the thermal demagnetization resistance can remarkably be improved.

### APPLICABILITY IN INDUSTRY

The present invention provides an R-T-B magnet having a chemical conversion layer with substantially the same corrosion resistance as that of the conventional chromate coating and good thermal demagnetization resistance, and a method for producing such R-T-B magnet, without using chromium harmful to humans and the environment.

What is claimed is:

1. A coated R-T-B magnet comprising an R-T-B magnet containing as a main phase an R₂T₁₄B intermetallic compound, wherein R is at least one of rare earth elements including Y, and T is Fe or Fe and Co, and a chemical conversion layer formed thereon, said chemical conversion layer containing an oxide of Mo and a hydroxide of R.

2. The coated R-T-B magnet according to claim 1, wherein said oxide of Mo is substantially amorphous MoO₂.

3. The coated R-T-B magnet according to claim 1 or 2, wherein a resin coating is formed on said chemical conversion layer.

4. The coated R-T-B magnet according to claim 3, wherein a resin coating is formed on said chemical conversion layer via a coupling agent coating.

5. A coated R-T-B magnet comprising an R-T-B magnet containing as a main phase an R₂T₁₄B intermetallic compound, wherein R is at least one of rare earth elements including Y, and T is Fe or Fe and Co, and a chemical conversion layer formed thereon, said chemical conversion layer containing pyrophosphoric acid, a hydroxide of R and an oxide of Mo.

6. The coated R-T-B magnet according to claim 5, wherein said oxide of Mo is substantially amorphous MoO₂.

7. The coated R-T-B magnet according to claim 5 or 6, wherein a resin coating is formed on said chemical conversion layer via a coupling agent coating.

8. A method for producing a coated R-T-B magnet comprising subjecting an R-T-B magnet containing as a main phase an R₂T₁₄B intermetallic compound, wherein R is at least one of rare earth elements including Y, and T is Fe or Fe and Co, to a chemical conversion treatment using a chemical conversion treatment solution containing molybdophosphate ion as a main component and having a molar ratio Mo/P of 12-60 and pH controlled to 4.2-6.

9. The method for producing the coated R-T-B magnet according to claim 8, wherein a resin is coated on said chemical conversion layer.

10. The method for producing the coated R-T-B magnet according to claim 8, wherein a resin is coated after said chemical conversion layer is surface-treated with a coupling agent.

11. A method for producing a coated R-T-B magnet comprising subjecting an R-T-B magnet containing as a main phase an R₂T₁₄B intermetallic compound, wherein R is at least one of rare earth elements including Y, and T is Fe or Fe and Co, to a chemical conversion treatment using a chemical conversion treatment solution containing phosphoric ion as a main component and having a molar ratio Mo/P of 0.3-0.9 and pH controlled to 2-5.8.

12. The method for producing the coated R-T-B magnet according to claim 11, wherein a resin is coated after said chemical conversion layer is surface-treated with a coupling agent.
